(19) United States
(12) Patent Application Publication
(10) Pub. No.: US 2024/0298626 A1
(43) Pub. Date: Sep. 12, 2024

(54) DUAL-BEARING REEL

(71) Applicant: GLOBERIDE, Inc, Tokyo (JP)

(72) Inventors: Yuichi UMEZAWA, Higashikurume-shi (JP); Hideki JO, Higashikurume-shi (JP); Saki FURUSE, Higashikurume-shi (JP)

(73) Assignee: GLOBERIDE, Inc, Tokyo (JP)

(21) Appl. No.: 18/543,006

(22) Filed: Dec. 18, 2023

(30) Foreign Application Priority Data
Mar. 6, 2023 (JP) 2023-033405

(51) Int. Cl. A01K 89/033; A01K 89/0155

(52) U.S. Cl. CPC A01K 89/033; A01K 89/01555

(57) ABSTRACT

A spool braking device comprises a conductive ring rotating integrally with a spool; a ring-shaped magnet disposed to face the conductive ring; a holding portion having a cylindrical shape and holding the ring-shaped magnet; and a movement operation mechanism that moves the holding portion having a cylindrical shape in an axial direction of the spool. The conductive ring comprises a facing surface facing the ring-shaped magnet, and the ring-shaped magnet is fixed such that a distal end side of the ring-shaped magnet protrudes inward in the axial direction with respect to an inner peripheral surface of the holding portion. The ring-shaped magnet is provided with a magnetic member that covers at least a portion of the distal end side protruding with respect to the inner peripheral surface of the holding portion, the portion facing an inner surface of a line winding drum portion in a radial direction.

### CROSS-REFERENCE TO RELATED APPLICATION

This application claims priority under 35 U.S.C. § 119 to Japanese Patent Application No. 2023-033405 filed on Mar. 6, 2023 in the Japanese Patent Office, the entire contents of each hereby incorporated by reference.

### BACKGROUND OF THE INVENTION

### 1. Technical Field

The present invention relates to a dual-bearing reel in which a spool around which a fishing line is wound is rotatably supported between left and right side plates forming a reel body.

### 2. Description of the Related Art

A body (reel body) of the dual-bearing reel described above includes left and right side plates in which a side plate (referred to as a cover member) is detachably attached to each of left and right frames. A spool around which a fishing line is wound is rotatably supported between the left and right side plates, and the spool is rotationally driven by performing an operation of winding a handle disposed on one side plate side, and the fishing line is wound around the spool.

As the dual-bearing reel described above, a downsized dual-bearing reel suitable for lure fishing has been known. In the lure fishing, as is well known, a lure is cast to a target position by switching a clutch mechanism from ON to OFF to set a spool free state and performing a casting operation, and thereafter, the clutch mechanism is set to ON, and a reeling operation is performed. In the casting operation, a spool braking device is incorporated in the side plate on an opposite side from a handle to prevent a backlash of the fishing line caused by the over-rotation of the spool.

Various types of the spool braking devices have been known, and there is a type in which a braking force is applied to the rotation of a spool at the time of casting by an electromagnetic induction method. For example, JP 2020-120587 A discloses a configuration in which a conductive ring is provided on a spool shaft so as to be integrally rotatable and a ring-shaped magnet is disposed to face an outer peripheral surface of the conductive ring. In such a spool braking device, when a spool rotates, an eddy current is generated on the surface of the conductive ring due to a magnetic field from the ring-shaped magnet, thereby being able to apply a braking force to the rotation of the spool shaft. In addition, in the spool braking device disclosed in JP 2020-120587 A, the conductive ring and the ring-shaped magnet are disposed in an accommodation space of the spool (inside a line winding drum portion in a radial direction), and the ring-shaped magnet is attached to an inner peripheral surface of a distal end of a holding portion having an annular shape. According to such a spool braking device, the diameter of the line winding drum portion can be made as small as possible, and it is possible to secure a line winding capacity while downsizing a reel body.

The ring-shaped magnet is moved in an axial direction by performing an operation of rotating an adjustment dial disposed on the side plate, so that the braking force acting on the spool can be adjusted. In addition, when the rotation speed of the spool increases, the conductive ring is moved in the axial direction due to cam action to increase a region facing the ring-shaped magnet, thereby improving the braking force.

### SUMMARY OF THE INVENTION

When lure fishing is performed using the dual-bearing reel described above, various types or weights of lures are used. In addition, there are also various casting methods when a lure is cast to a target position, such as short-range casting, long-range casting, and casting to avoid an obstacle (overhead casting, side casting, skipping, pitching, and the like). When casting a lure, an angler operates an adjustment member (adjustment dial) for adjusting the braking force of the spool braking device described above such that a backlash does not occur.

In the above-described type of dual-bearing reel, in order to increase the line winding capacity of the spool and reduce the size and weight of the spool, it is necessary to make the diameter of the line winding drum portion of the spool as small as possible, and dispose the spool close to the conductive ring (induction rotor) forming the spool braking device. However, when the line winding drum portion is disposed too close to the conductive ring, the magnetic field of the ring-shaped magnet interposed between the line winding drum portion and the conductive ring may act on a spool side, and a braking force may directly act on the spool.

For this reason, when a very light lure (approximately 1 g to 5 g) is cast during actual fishing, the braking force directly acts on the spool, and when light casting such as pitching is performed, the lure cannot be smoothly cast to a target point. When the magnetic force of the ring-shaped magnet is set to be weak (setting of the adjustment dial) to match the very light lure, in a casting operation that requires a strong braking force, such as overhead casting, side casting, or skipping, the braking force may be insufficient, thereby causing a backlash.

Namely, when casting in which there is a difference in the rotational input of the spool is performed, such as performing overhead casting or side casting and performing pitching, it is difficult to perform a casting operation at the same setting value of the adjustment dial, so that casting adaptability decreases.

The present invention has been made in view of the above-described problems, and an object of the present invention is to provide a dual-bearing reel comprising a spool braking device that prevents a decrease in casting adaptability even when various cast forms or lures having different weights are used.

In order to achieve the above-described object, a dual-bearing reel according to the present invention comprises a spool braking device rotatably supporting a spool between side plates of a reel body and applying a braking force to a rotation of the spool, the spool comprising a line winding drum portion around which a fishing line is wound, and flange portions formed on both sides of the line winding drum portion. The spool braking device comprises a conductive ring rotating integrally with the spool, a ring-shaped magnet disposed to face the conductive ring, a holding portion having a cylindrical shape and holding the ring-shaped magnet, and a movement operation mechanism that is provided on the reel body and that moves the holding portion having a cylindrical shape in an axial direction of the spool. The conductive ring comprises a facing surface facing the ring-shaped magnet. The ring-shaped magnet is fixed such that a distal end side of the ring-shaped magnet protrudes inward in the axial direction with respect to an inner peripheral surface of the holding portion. The ring-shaped magnet is provided with a magnetic member that covers at least a portion of the distal end side protruding with respect to the inner peripheral surface of the holding portion, the portion facing an inner surface of the line winding drum portion in a radial direction.

In the spool braking device described above, the ring-shaped magnet is fixed such that the distal end side thereof protrudes inward in the axial direction with respect to the inner peripheral surface of the holding portion, so that the reel body can be efficiently downsized. In addition, since the magnetic member is provided on the ring-shaped magnet to cover the portion of the ring-shaped magnet facing the inner surface of the line winding drum portion of the spool in the radial direction, the action of a magnetic force from the ring-shaped magnet on the spool is suppressed. Accordingly, a braking force does not act on the spool, so that the flying distance of a light lure when being cast does not decrease. Further, since the magnetic force is directed inward in the radial direction by disposing the magnetic member as described above, the magnetic force acting on the conductive ring is increased. Therefore, the braking force acts firmly in casting in which a rotational input is strong, and the braking force acting on the spool is weak in casting in which a rotational input is weak, so that even when lures having different weights are cast or the cast form is different, casting adaptability does not decrease. According to the present invention, it is possible to obtain the dual-bearing reel comprising the spool braking device that prevents a decrease in casting adaptability even when various cast forms or lures having different weights are used.

### BRIEF DESCRIPTION OF THE DRAWINGS

FIG. 1 is a plan view illustrating one embodiment of a dual-bearing reel according to the present invention;

FIG. 2 is a side view of the dual-bearing reel illustrated in FIG. 1 when viewed from an opposite side from a handle;

FIG. 3 is a view illustrating a spool braking device portion in FIG. 1;

FIG. 4A is an enlarged view of the spool braking device portion in FIG. 3, and FIG. 4B is a perspective view illustrating a configuration of a ring-shaped magnet and a magnetic member;

FIG. 5 is a view illustrating a modification example of the magnetic member; and

FIG. 6 is a view illustrating a modification example of a conductive ring.

### DETAILED DESCRIPTION

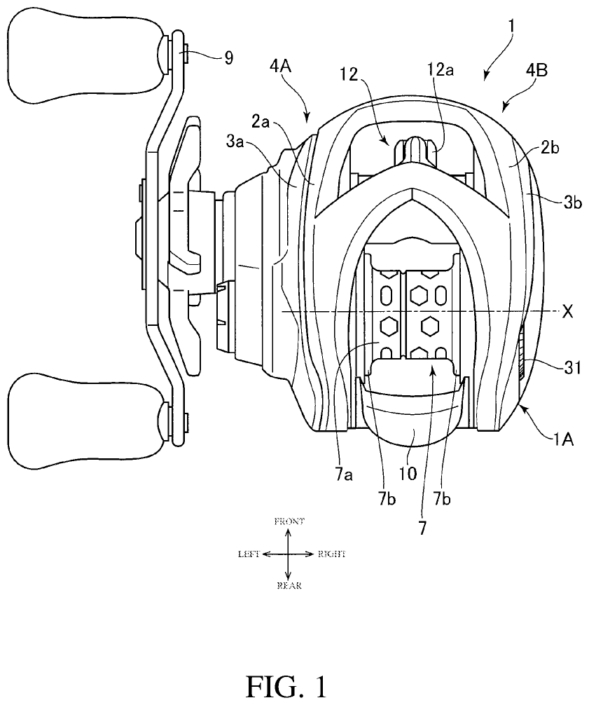

Hereinafter, one embodiment of a dual-bearing reel according to the present invention will be described with reference to FIGS. 1 to 4B.

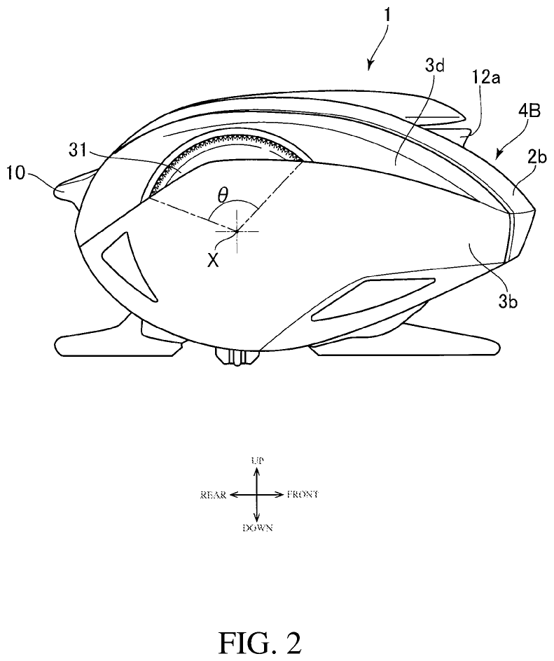

In the following description, a front-rear direction, a left-right direction, and an up-down direction are defined as directions illustrated in FIGS. 1 and 2, and an axial direction X is defined as an axial direction of a spool shaft. For this reason, the inside in the axial direction is a center side of a spool when a spool braking device is used as a reference, and the outside in the axial direction is a side plate side of a reel body when the spool braking device is used as a reference.

A reel body 1A of a dual-bearing reel 1 according to the present embodiment comprises left and right side plates 4A and 4B in which left and right frames 2a and 2b are covered with left and right covers 3a and 3b, respectively. A spool shaft 5 is rotatably supported between the left and right side plates via bearings (a bearing on a right frame side is illustrated) 6.

In addition, a spool 7 around which a fishing line is wound is provided on the spool shaft 5 so as to be rotatable integrally with the spool shaft 5. The spool is made of lightweight metal (non-magnetic conductor) such as an aluminum alloy or a copper alloy, and rotates integrally with the spool shaft 5. The spool 7 comprises a line winding drum portion 7a around which the fishing line is wound; flange portions 7b integrally formed on both left and right sides of the line winding drum portion 7a; and a central annular wall 7c integrally formed at the center of an inner surface of the line winding drum portion 7a, and the fishing line is wound around the line winding drum portion 7a while being restricted by the left and right flange portions 7b. In addition, a support portion 7d having a tubular shape is integrally formed at a rotation center portion of the spool 7, and the support portion 7d is externally fitted to the spool shaft 5 along the axial direction.

The left side plate 4A is provided with a handle 9, and by performing an operation of winding the handle 9, the spool 7 is rotationally driven via a driving force transmission mechanism (not illustrated) disposed inside the left side plate (left handle type). The handle 9 may be configured to be disposed on a right side plate 4B side. In addition, a known clutch mechanism that switches the spool shaft 5 between a power transmission state and a power cut-off state is disposed between the right frame 2b and the right cover 3b, and is configured such that the clutch mechanism is switched from a clutch ON state (power transmission state) to a clutch OFF state (power cut-off state; spool free rotation state) by performing an operation of pushing down a clutch switching operation member 10 disposed between the left and right side plates on the rear side of the spool 7. The return from the clutch OFF state to the clutch ON state can be performed by rotationally operating the handle 9 via a known return mechanism.

A known level wind device 12 is disposed between the left and right side plates 4A and 4B on a side of the spool 7 in a fishing line payout direction. The level wind device 12 is configured such that a fishing line guide body 12a into which the fishing line is inserted is moved leftward and rightward by rotationally operating the handle 9, and the fishing line is evenly wound around the line winding drum portion 7a of the spool 7 along with a winding operation of the fishing line.

In addition, a spool braking device 20 that applies a braking force to the rotation of the spool 7 to prevent over-rotation when the fishing line is released is disposed on the side plate on an opposite side from the handle (right side plate side). Hereinafter, a configuration of the spool braking device 20 of the present embodiment will be described.

The spool braking device 20 has the function of applying a braking force to the spool through magnetic action when the spool 7 over-rotates in a spool free rotation state. As is well known, the spool braking device 20 of the present invention comprises a ring-shaped magnet 21 provided on a reel body side, and a conductive ring (induction rotor) 25 that is provided on a spool side and that generates an eddy current using a magnetic force generated from the ring-shaped magnet 21, to apply a braking force to the rotation of the spool 7.

The ring-shaped magnet 21 can be formed in an annular shape in advance, or can be composed of a large number of magnets disposed side by side in an annular shape, and has a configuration in which N poles and S poles are magnetized in a radial direction. In addition, the ring-shaped magnet 21 is held by the reel body 1A, in detail, a holding portion 22 having a cylindrical shape and provided to be movable in the left-right direction along the axial direction X with respect to a set plate 2d provided on the right frame 2b.

The ring-shaped magnet 21 is disposed along a circumferential direction on an inner peripheral surface 22a on a distal end side of the holding portion 22 made of hard resin or the like such that the ring-shaped magnet 21 does not become thick in the radial direction and is easy to assemble. Namely, the ring-shaped magnet 21 is formed in a cylindrical shape, and is press-fitted and fixed to the inner peripheral surface on the distal end side of the holding portion 22 formed in a cylindrical shape, in the axial direction, so that the ring-shaped magnet 21 is held. In addition, a step portion 22b against which an opening edge of the ring-shaped magnet 21 that is press-fitted is abutted is formed at an inner portion of the holding portion 22. According to such a holding mode, an operation of assembling the ring-shaped magnet 21 is facilitated and the holding state is also stabilized.

One end side of the spool shaft 5 is rotatably supported by a support portion 2e of the set plate 2d via the bearing 6. In addition, the holding portion 22 is movable in the axial direction X by a movement operation mechanism 30 provided on the reel body 1A. The movement operation mechanism 30 of the present embodiment comprises an adjustment dial 31 having a disk shape and provided on the right side plate 4B side forming the reel body 1A, and is configured such that the holding portion 22 (ring-shaped magnet 21) is moved in the left-right direction by rotationally operating the adjustment dial 31 with the right hand that grips the right side plate 4B.

As illustrated in FIG. 2, an opening 3d is formed on an upper side of the right cover 3b, and the adjustment dial 31 is supported to be rotatable with respect to the right side plate such that a region at a predetermined angle θ above the opening 3d is exposed. An annular portion 31a having a large diameter and concentric with the support portion 2e of the set plate 2d is formed to protrude inside the adjustment dial 31. The holding portion 22 is held to be movable in the axial direction with respect to the annular portion 31a in a state where the holding portion 22 pinches the annular portion 31a.

A spiral rail member 33 having a cylindrical shape and forming the movement operation mechanism 30 is fixed to the support portion 2e, and an engagement portion formed on an inner surface of the holding portion 22 pinching the annular portion 31a is engaged with a spiral groove 33a formed on an outer surface of the spiral rail member 33. Accordingly, when the adjustment dial 31 is rotationally operated, the annular portion 31a of the adjustment dial 31 rotates outside the spiral rail member 33. As described above, due to the engagement relationship between the holding portion 22 and the spiral groove 33a, the holding portion 22 moves toward or away from the spool 7 along the axial direction. Namely, since the holding portion 22 is moved in the axial direction in response to the rotational operation of the adjustment dial 31, the ring-shaped magnet 21 fixed to the inner peripheral surface 22a on the distal end side of the holding portion 22 also moves in the axial direction together with the holding portion. In such a manner, since the adjustment dial 31 adjusts the initial position of a facing distance (magnetic force) of the ring-shaped magnet 21 with respect to the conductive ring 25, the braking force or braking characteristics at the initial stage of braking can be adjusted in advance.

The conductive ring 25 is fixed to an outer surface of a movement member 50 that is rotationally restrained to be movable in the axial direction with respect to the support portion 7d of the spool 7, and rotates integrally with the spool 7. The conductive ring 25 is made of a non-magnetic material having conductivity such as aluminum (aluminum alloy) or copper (copper alloy), and comprises a facing surface facing the ring-shaped magnet 21. Namely, the ring-shaped magnet 21 is disposed to face the facing surface of the conductive ring 25.

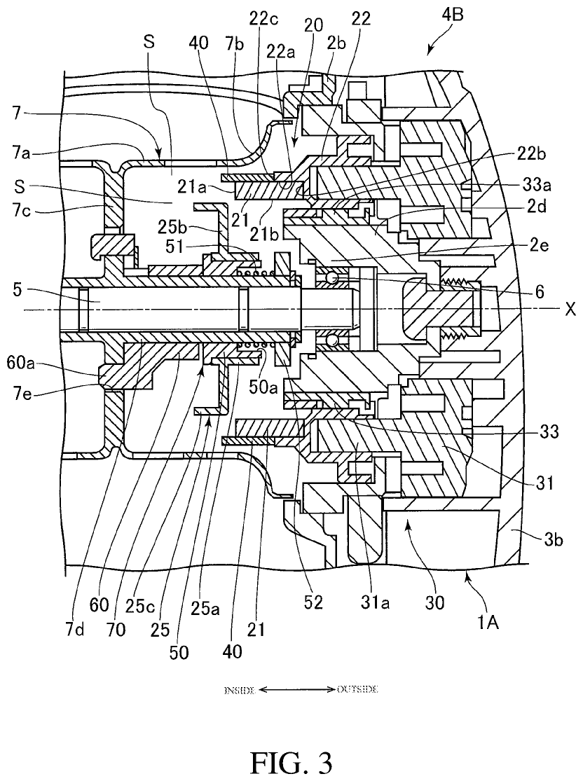

The facing surface of the conductive ring 25 conforms to the shape of the conductive ring 25, and the conductive ring 25 of the present embodiment comprises a cylindrical portion 25c facing the ring-shaped magnet 21 in the radial direction, and the facing surface is configured as an outer peripheral surface of the cylindrical portion 25c. In this case, the conductive ring 25 may be configured such that the cylindrical portion 25c always overlaps the ring-shaped magnet 21 in the radial direction; however, in the present embodiment, as illustrated in FIG. 3, the conductive ring 25 is configured such that the cylindrical portion 25c is located not to overlap the ring-shaped magnet 21 in the radial direction when the spool 7 is in a non-rotation state. In addition, even when the ring-shaped magnet 21 is installed on an innermost side in the axial direction by the operation of the adjustment dial 31, the cylindrical portion 25c and the ring-shaped magnet 21 are configured to be located not to overlap each other in the radial direction.

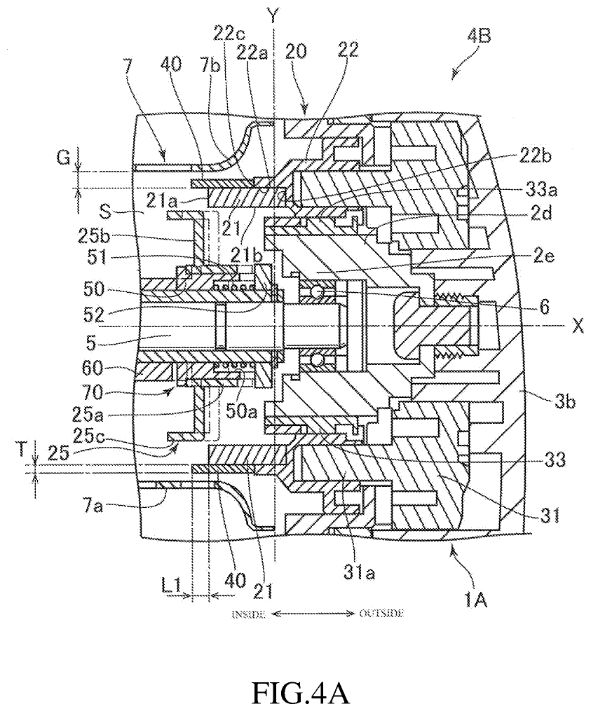

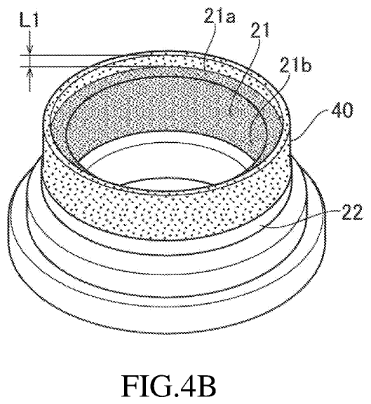

As will be described later, the conductive ring 25 of the present embodiment is configured to move in the axial direction along with the rotation of the spool 7. Namely, in a state where the spool 7 is not in rotation, the conductive ring 25 is located in a state indicated by a solid line in FIG. 4A, and in this state, the conductive ring 25 is disposed to be located inside the flange portion 7b of the spool 7 in the axial direction X. Specifically, the conductive ring 25 is disposed to be located inside an axially outer end surface (in FIG. 4A, such an outer end surface is indicated by an outer end surface Y) of the flange portion 7b in the axial direction, the axially outer end surface being on an opposite side from the handle 9 inside the spool 7, and in an accommodation space S present inside the line winding drum portion 7a in the radial direction. The accommodation space S is a portion located inside the axially outer end surface Y of the flange portion 7b in the axial direction, and surrounded by the line winding drum portion 7a, the central annular wall 7c, and the support portion 7d of the spool 7.

The ring-shaped magnet 21 that is moved in the axial direction by a rotational operation of the adjustment dial 31 is held by the holding portion 22 such that at least a part of the ring-shaped magnet 21 is movable in the axial direction within a range inside the flange portion 7b of the spool 7 in the axial direction. Namely, FIG. 4A illustrates a position where the ring-shaped magnet 21 is farthest away from the spool, and in this state, a distal end surface 21a of the ring-shaped magnet 21 is disposed to be located inside a position indicated by the outer end surface Y in the axial direction. According to such a configuration, the reel body can be made compact in the left-right direction. The ring-shaped magnet 21 may be disposed such that the entire region of the ring-shaped magnet 21 is located inside the position indicated by the outer end surface Y in the axial direction when the ring-shaped magnet 21 is moved in the axial direction by a rotational operation of the adjustment dial 31. According to such a configuration, the reel body can be made further compact in the left-right direction.

As described above, the ring-shaped magnet 21 is press-fitted and fixed to the inner peripheral surface 22a on the distal end side of the holding portion 22 formed in a cylindrical shape, and is fixed such that a distal end side 21b protrudes inward in the axial direction with respect to the inner peripheral surface of the holding portion 22. For this reason, a magnetic field from the ring-shaped magnet 21 acts on the spool 7; however, as will be described below, a protruding portion of the ring-shaped magnet 21 is covered with a magnetic member 40, so that the magnetic field acting on the spool 7 is reduced. Namely, the magnetic member 40 is provided on the ring-shaped magnet 21 to cover at least a portion (outer surface of the ring-shaped magnet 21) of the distal end side 21b protruding from the inner peripheral surface of the holding portion 22, the portion facing the inner surface of the line winding drum portion 7a of the spool 7 in the radial direction.

In consideration of workability, attachability, and the like, as illustrated in FIG. 4B, the magnetic member 40 can be configured as a tubular body covering the distal end side of the ring-shaped magnet 21, and can be integrally formed of, for example, an iron ring. The magnetic member 40 of the present embodiment is formed to such a thickness that the magnetic member 40 becomes substantially flush with an outer peripheral surface of the holding portion 22, so that a reduction in thickness is achieved. In addition, it is preferable that the magnetic member 40 is subjected to a surface treatment such as a plating treatment to prevent rust or the like from occurring even when the magnetic member 40 is used in an environment where salt is likely to adhere thereto, such as the sea.

The magnetic member 40 may have the function of being able to suppress leakage of the magnetic field of the ring-shaped magnet 21 to a line winding drum portion 7a side of the spool 7. For this reason, the magnetic member 40 may be formed such that an end of the magnetic member 40 is located at the same position as an end of the ring-shaped magnet 21 or protrudes inward in the axial direction from the end of the ring-shaped magnet 21 (preferably, a protrusion amount L1 is approximately 0 to 0.5 mm).

Next, a configuration for moving the conductive ring 25 in the axial direction will be described. The conductive ring 25 is fixed to an outer peripheral surface of the movement member 50 disposed to be movable in the axial direction with respect to the spool shaft 5. The movement member 50 is movable in the axial direction according to the rotation speed of the spool 7 to be changed in position facing the ring-shaped magnet 21 in the radial direction. Specifically, as the rotation speed of the spool 7 rises, the movement member 50 moves such that the conductive ring 25 approaches the ring-shaped magnet 21, and accordingly, an electromagnetic force (braking force) acting on the conductive ring 25 increases and the braking force on the spool 7 increases. In this case, in a state where the spool 7 is not in rotation, as indicated by the solid line in FIG. 4A, the conductive ring 25 is disposed to be located inside the flange portion 7b of the spool 7 in the axial direction X.

The movement member 50 is formed in a tubular shape into which the support portion 7d of the spool 7 is inserted, and is movable in the axial direction along the spool shaft 5, and the conductive ring 25 is fixed to the outer peripheral surface of the movement member 50. A recess 50a is formed at an axial portion on the right side plate side of the movement member 50, and one end of a biasing member (biasing spring) 51 is abutted against a bottom surface of the recess 50a. Then, the other end of the biasing member 51 is abutted against a retainer 52 fixed to the support portion 7d, and accordingly, the movement member 50 is always biased toward the inside in the axial direction (toward a fixation member 60 side to be described later).

The conductive ring 25 of the present embodiment comprises a base portion 25a fixed to the outer peripheral surface of the movement member 50; an annular wall 25b bent at an end of the base portion 25a and extending in the radial direction; and the cylindrical portion 25c bent in the axial direction at a distal end of the annular wall 25b and facing the ring-shaped magnet 21 in the radial direction. The cylindrical portion 25c moves together with the conductive ring according to the rotation speed of the spool 7 such that the relative position of the cylindrical portion 25c with respect to the ring-shaped magnet 21 can be changed.

The fixation member 60 having a tubular shape is disposed adjacent to the movement member 50 on the support portion 7d. The fixation member 60 is non-rotatably fitted to the support portion 7d, comprises an engagement projection 60a, is fitted to a fitting portion 7e formed in the central annular wall 7c of the spool 7, and is rotatable integrally with the spool 7. In addition, the movement member 50 and the fixation member 60 comprises respective cam portions 70 that come into surface contact with each other through axially facing surfaces, and the movement member 50 moves in the axial direction due to the cam action of the cam portions 70 according to the rotation speed of the spool 7 at the time of casting. Namely, the movement member 50 to which the conductive ring 25 is attached is biased inward in the axial direction by the biasing force of the biasing member 51 before a casting operation, and when the spool 7 rotates at high speed at the time of casting, the movement member 50 moves toward the right frame 2b side along the axial direction against the biasing force of the biasing member 51 due to the cam action of the cam portions 70.

Since the cam portions 70 provided between the movement member 50 and the fixation member 60 are generally well known, the description of details thereof will be omitted; however, the cam portions 70 comprises cam surfaces on the respective facing surfaces, and the cam surfaces have a shape that allows the fixation member 60 rotating integrally with the spool 7 to move the movement member 50 along the spool shaft. Specifically, when the clutch mechanism is set to OFF and the spool 7 is rotated in a fishing line release direction, an axial force component acting on the cam surfaces increases as the rotation speed of the fixation member 60 increases together with the spool 7. Then, when the axial force component becomes larger than the biasing force of the biasing member 51, the movement member 50 moves toward the right frame 2b side, and the cylindrical portion 25c of the conductive ring 25 faces the ring-shaped magnet 21 in the radial direction. For this reason, the braking force acting on the conductive ring 25 increases, and the braking force that suppresses over-rotation acts on the spool 7.

In addition, when the rotation speed of the fixation member 60 decreases together with the spool 7, the movement member 50 is moved toward a left frame 2a side by the biasing force of the biasing member 51. Accordingly, the cylindrical portion 25c moves in the axial direction away from the ring-shaped magnet 21, and the braking force acting on the conductive ring 25 weakens. Namely, the spool braking device 20 of the present embodiment functions such that the braking force on the spool 7 increases when the rotation speed of the spool 7 increases, and the braking force weakens when the rotation speed of the spool 7 decreases.

As described above, the conductive ring 25 is disposed at a position where the cylindrical portion 25c facing the ring-shaped magnet 21 in the radial direction does not overlap the ring-shaped magnet 21 in the radial direction when the spool 7 is in a non-rotation state. With such a setting, when the spool 7 starts to rotate at the time of casting, the ring-shaped magnet 21 and the cylindrical portion 25c do not overlap each other in the radial direction, so that the generation of a strong braking force on the conductive ring 25 can be suppressed.

In addition, by appropriately modifying the inclination angle of each cam surface of the cam portions 70 formed on facing portions of the movement member 50 and the fixation member 60 described above, the biasing force of the biasing member 51, or the like, the movement amount of the movement member 50 is adjusted, so that the braking characteristics can be changed. In addition, since the position of the ring-shaped magnet 21 in the axial direction can be changed by the adjustment dial 31 described above, the braking force acting when the spool rotates can be adjusted by changing the initial position of the adjustment dial 31.

It is preferable that forming materials of the movement member 50 and the fixation member 60 described above have high hardness, high wear resistance, and low specific gravity. The movement member 50 and the fixation member 60 can be made of, for example, resin such as ABS resin, PC resin, nylon resin, polyacetal resin, or POM resin, or lightweight metal such as aluminum.

Next, actions of the spool braking device 20 described above will be described. According to the spool braking device 20 with the above-described configuration, the conductive ring 25 rotating integrally with the spool 7 is located inside the flange portion 7b of the spool 7 in the axial direction, and the ring-shaped magnet 21 is fixed such that the distal end side of the ring-shaped magnet 21 protrudes inward in the axial direction with respect to the inner peripheral surface 22a of the holding portion 22, so that the reel body can be efficiently downsized.

In addition, since the magnetic member 40 is provided on the ring-shaped magnet 21 to cover the portion of the ring-shaped magnet 21 facing the inner surface of the line winding drum portion 7a of the spool 7 in the radial direction, the action of the magnetic force from the ring-shaped magnet 21 on the spool is suppressed. Accordingly, when a very light lure (approximately 1 g to 5 g) is cast using pitching or the like, the braking force acting on the spool 7 is suppressed, and the lure can be smoothly cast to a target point. Particularly, in the present embodiment, since the magnetic force acting on the spool side is suppressed by the magnetic member 40, and the cylindrical portion 25c of the conductive ring 25 does not overlap the ring-shaped magnet 21 in the radial direction, the generation of a strong braking force on the conductive ring 25 is suppressed, and smoother rotation characteristics of the spool 7 can be obtained.

Then, when the spool 7 rotates at high speed to some extent, the movement member 50 moves outward in the axial direction due to the cam action. Accordingly, the cylindrical portion 25c of the conductive ring 25 moves in the axial direction, and overlaps the ring-shaped magnet 21 in the radial direction, and the braking force starts to act, so that the occurrence of a backlash is prevented.

When the distance between the line winding drum portion 7a of the spool 7 and the ring-shaped magnet 21 increases, the magnetic field acting on the line winding drum portion 7a of the spool 7 also weakens, so that the necessity of providing the magnetic member 40 described above is diminished. However, when it is considered that the entirety of the reel is downsized while forming the line winding drum portion 7a as deep a groove as possible in order to secure a line winding capacity, it is preferable that the minimum gap between the inner surface of the line winding drum portion 7a and the outer surface of the ring-shaped magnet 21 is set to be as small as possible (gap is set to the extent that the magnetic force acts on the line winding drum portion 7a). In practice, regarding a minimum gap G between the inner surface of the line winding drum portion 7a and the outer surface of the ring-shaped magnet 21, the minimum gap is set to 1.5 mm or less, preferably 1.2 mm or less, and more preferably 1.0 mm or less, and it is preferable that a thickness T of the magnetic member 40 is less than or equal to half of the minimum gap G. With such a numerical relationship, even when the reel body is small, the line winding capacity is secured, and a lure is very light, the magnetic force acting on the spool can be reduced, and casting to a target point can be smoothly performed.

In addition, by disposing the magnetic member 40 on the ring-shaped magnet 21 as described above, the magnetic force (magnetic flux density) toward the line winding drum portion 7a side (outside in the radial direction) of the spool 7 is reversed toward the inside in the radial direction, so that the magnetic force concentrates on the conductive ring 25 portion that controls the ON/OFF of braking, and a distinct contrast is obtained, thereby increasing the strength and weakness of the braking. Accordingly, braking is firmly applied in casting in which an input is strong (overhead casting, side casting, or the like), and braking is released in casting in which an input is weak (pitching or the like), lure adaptability for light lures is improved. Namely, even when lures having different weights are used or a cast form is changed with the adjustment dial 31 set at the same position, the flying distance does not decrease, a backlash does not occur, and the lure adaptability or casting adaptability does not decrease.

Here, five dual-bearing reels in which the spool braking device 20 with the above-described configuration is incorporated were created, and verification was performed for cases where the magnetic member (iron ring) 40 is not provided and where the magnetic member 40 is provided. When the verification was performed, a magnetic flux density in the accommodation space S (inside), a magnetic flux density outside the magnetic member 40 (gap G), and a magnetic flux density at the distal end surface 21a of the ring-shaped magnet 21 were measured, and the average value thereof was taken. Hereinafter, measurement results are shown in Table 1.

TABLE 1

| | |
|---|---|
| | Average |
| Presence or absence | Magnetic flux density (G) |

| of iron ring | Inside | Distal end surface | Outside |
|---|---|---|---|
| Absence | 1965 | 430 | 1598 |
| Presence | 2270 | 404 | 433 |

As per the measurement results described above, by fixing the magnetic member 40 to the ring-shaped magnet 21, the magnetic flux density thereinside is improved and the magnetic flux density thereoutside decreases, so that a distinct contrast between the strength and weakness of braking is obtained. Therefore, the action of braking is suppressed in light casting (light lure), and braking firmly acts in strong casting (heavy lure), so that a backlash can be effectively suppressed.

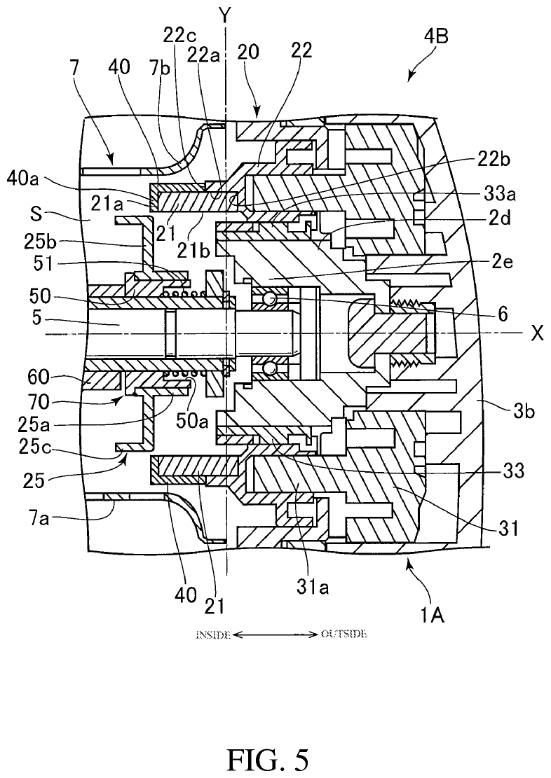

The embodiment of the present invention has been described above; however, the present invention is not limited to the above-described embodiment, and can be modified in various forms. The shape of the magnetic member 40 described above can be appropriately modified by changing the thickness or forming a projection portion or groove. In addition, in the above-described embodiment, the magnetic member 40 is configured to cover the surface portion of the ring-shaped magnet 21; however, for example, as illustrated in FIG. 5, a distal end side 40a of the magnetic member 40 may be bent to cover an outer surface of a protruding end of the ring-shaped magnet 21 and an end surface on the inner side in the axial direction (the distal end surface 21a of the ring-shaped magnet 21). According to such a configuration, a leakage of magnetic fluxes can be more reliably prevented, and the magnetic force acting on the spool 7 can be further suppressed.

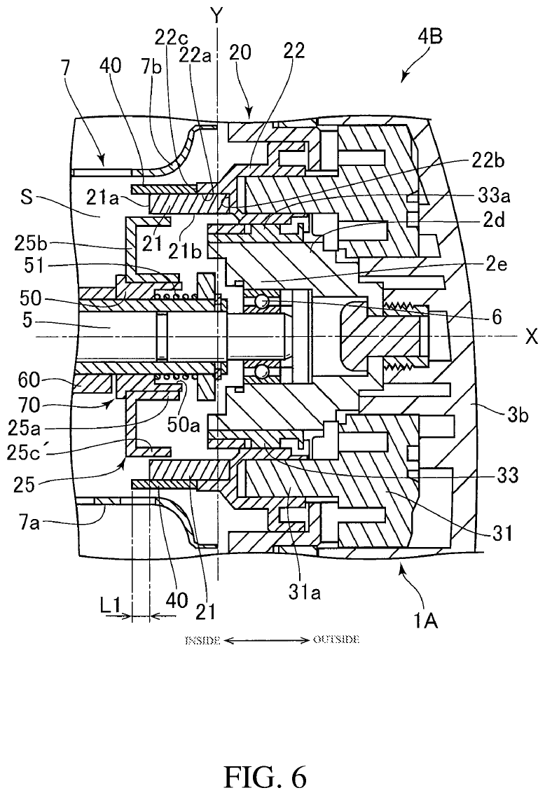

In addition, the shape of the conductive ring 25 is not particularly limited, and can be modified into various shapes. For example, as illustrated in FIG. 6, a cylindrical portion 25c′ may be bent opposite to the configuration of the cylindrical portion 25c of the embodiment, and in an initial state, the cylindrical portion 25c′ may be configured to overlap (partially overlap) the ring-shaped magnet 21 in the radial direction. According to such a configuration, a braking force can be slightly applied to the spool 7 during initial rotation.

In addition, the ring-shaped magnet 21 is movable in the axial direction in the accommodation space S described above by a rotational operation of the adjustment dial 31, but may be held by the holding portion 22 such that a part of the ring-shaped magnet overlaps the axially outer end surface Y of the flange portion 7b when the ring-shaped magnet is moved farthest outward in the axial direction.

As described above, the present invention is characterized in the configuration of the spool braking device 20, and the shape or configuration of the reel body is not particularly limited. The method for moving the ring-shaped magnet 21 in the axial direction can be modified as appropriate into a gear method, a cam method, or the like. Further, a change in the relative position of the ring-shaped magnet 21 facing the conductive ring 25 is appropriately set according to the braking characteristics, reel specifications, or the like.

What is claimed is:

1. A dual-bearing reel comprising:
a spool braking device rotatably supporting a spool between side plates of a reel body and applying a braking force to a rotation of the spool, the spool comprising a line winding drum portion around which a fishing line is wound, and flange portions formed on both sides of the line winding drum portion, wherein
the spool braking device comprises a conductive ring rotating integrally with the spool, a ring-shaped magnet disposed to face the conductive ring, a holding portion having a cylindrical shape and holding the ring-shaped magnet, and a movement operation mechanism that is provided on the reel body and that moves the holding portion having a cylindrical shape in an axial direction of the spool,
the conductive ring comprises a facing surface facing the ring-shaped magnet,
the ring-shaped magnet is fixed such that a distal end side of the ring-shaped magnet protrudes inward in the axial direction with respect to an inner peripheral surface of the holding portion, and
the ring-shaped magnet is provided with a magnetic member that covers at least a portion of the distal end side protruding with respect to the inner peripheral surface of the holding portion, the portion facing an inner surface of the line winding drum portion in a radial direction.

2. The dual-bearing reel according to claim 1, wherein
the magnetic member is a tubular body covering the protruding distal end side of the ring-shaped magnet, and
an end of the tubular body is located at the same position as an end of the ring-shaped magnet, or protrudes inward in the axial direction from the end of the ring-shaped magnet.

3. The dual-bearing reel according to claim 1, wherein the magnetic member covers an outer surface of a protruding end of the ring-shaped magnet and an end surface on an inner side of the ring-shaped magnet in the axial direction.

4. The dual-bearing reel according to claim 1, wherein the conductive ring is fixed to a movement member disposed to be movable in the axial direction with respect to a rotating shaft of the spool, and the movement member is movable according to a rotation speed of the spool to be changed in a position facing the ring-shaped magnet in the radial direction.

5. The dual-bearing reel according to claim 4, wherein
the conductive ring comprises a cylindrical portion facing the ring-shaped magnet in the radial direction, and
the cylindrical portion is located not to overlap the ring-shaped magnet in the radial direction when the spool is in a non-rotation state.

6. The dual-bearing reel according to claim 1, wherein
a minimum gap between the inner surface of the line winding drum portion of the spool and an outer surface of the ring-shaped magnet in the radial direction is 1.0 mm or less, and
a thickness of the magnetic member is less than or equal to half of the minimum gap.

7. The dual-bearing reel according to claim 1, wherein the magnetic member is subjected to a plating treatment.

8. The dual-bearing reel according to claim 1, wherein
the movement operation mechanism comprises an adjustment dial that is rotatably provided on the reel body and that moves the holding portion having a cylindrical shape in the axial direction of the spool, and
the ring-shaped magnet is held by the holding portion such that at least a part of the ring-shaped magnet is movable in the axial direction within a range inside the flange portions of the spool in the axial direction when the adjustment dial is rotationally operated.
